(19) United States
(12) Patent Application Publication
(10) Pub. No.: US 2004/0148372 A1
(43) Pub. Date: Jul. 29, 2004

(54) Web-browser based heterogeneous systems management tool

(76) Inventor: David N. Campbell, Oakville (CA)

Correspondence Address: Mark B. Eisen, Dimock Stratton Clarizio LLP, 20 Queen Street West, Suite 3202, Box 102, Toronto, ON, M5H 3R3, CA

(21) Appl. No.: 10/351,349

(22) Filed: Jan. 27, 2003

(51) Int. Cl. G06F 15/16; G06F 15/173

(52) U.S. Cl. 709/223; 713/201; 709/229

(57) ABSTRACT

A web-browser-based heterogeneous systems management tool allows users to remotely, via wireless devices, perform basic services, administration and maintenance of heterogeneous systems, desktops, networked printers, routers and switches, through the use of an application web server. The application web server access a managed systems database for permitting access to users and for providing information to users to permit support to be carried out. Resident management agents run on each of the managed systems to permit commands to be passed to the operating systems of the managed systems. Users may access a specified target system using any web-based wireless device to perform routine tasks and system administration functions from anywhere in the wireless carriers' covered areas.

### TECHNICAL FIELD

This patent application is related, in general, to management of information technology systems and in particular to a browser-based systems management system.

### BACKGROUND

Information systems and infrastructures are subject to rapid change. The introduction of world wide web and wireless technologies makes such change more pronounced. Typical computer system infrastructures now include systems running operating systems such as Microsoft Windows™, Linux, Unix variants as well as legacy systems. Companies with such various operating systems are challenged in supporting and managing all these different technologies and applications. It is becoming more difficult and expensive to manage the many diverse systems that make up corporate networks. Each operating system or device in the infrastructure requires specialized knowledge, training and technical support. This knowledge and investment may be lost when systems are changed or employees depart.

Furthermore, routine system support tasks, such as basic administration, maintenance and management of these systems require intervention by system operators and administrators, typically by technology users trained for the specific system being dealt with and who access the system using a desktop computer that may be wired to an internet, intranet or extranet. Each such access for the different types of systems will be accomplished with different security levels and authorizations.

Such access is typically dependent on the characteristics of the system being accessed and the user accessing the system will require specific knowledge to effectively take steps to manage the particular system being accessed.

It is therefore desirable to have a system tool that provides a consistent and convenient access format to permit common system problems to be resolved by non-technical personnel in a secure and timely fashion. It is also desirable to provide such a system tool that may be accessed using web browsers via wireless and wired devices.

### SUMMARY OF THE INVENTION

According to one aspect of the current invention, an improved systems management tool is provided.

According to another aspect of the invention a web-browser-based management tool is provided to permit first line support and helpdesk staff (tech-users) to remotely, via wireless devices, perform basic services, administration and maintenance of heterogeneous servers, desktops, networked printers, routers and switches, through the use of a web server based Universal Management Application Program (UMAP), Managed Systems Data Base (MSDB) and Resident Management Agents (RMA) for managed systems. Tech-users can access the target system via an enquiry from the Data Base, using any wireless device equipped with alphanumeric keypad and perform routine tasks and system administration functions from anywhere in the wireless carriers' covered areas or the internet.

According to an aspect of the invention there is provided a secure, simple, untethered and ubiquitous controlling access for first line tech-users to perform basic operations on various computer (information technology or IT) systems

According to another aspect of the invention there is provided a universal IT systems management tool wherein the IT tech-user (tech-user) need not be an expert in the various operating systems and heterogeneous systems environment

According to another aspect of the invention there is provided a tool to allow tech-users to access the IT management systems from a wireless web browser and wireless device equipped with basic alphanumeric keys.

According to another aspect of the invention there is provided a customization tool for pre-defining the various tasks and authorities for each certified tech-user equipped with the wireless device and authentication id and password.

The above aspects of the invention and the brief description of the preferred embodiment should be construed to be merely illustrative of some of the more prominent features and applications of the invention. Many other beneficial results can be attained by applying the disclosed invention in a different manner or modifying the invention as will be described. Accordingly, other objects and a fuller understanding of the invention may be had by referring to the following Detailed

### DESCRIPTION OF THE PREFERRED EMBODIMENT

### BRIEF DESCRIPTION OF THE FIGURES

100131 For a more complete understanding of the present invention and the advantages thereof, reference should be made to the following Detailed Description taken in connection with the accompanying drawings in which:

FIG. 1 is a block diagram of the overall network and relationship diagram, showing a preferred embodiment of the invention;

FIG. 2 is a detailed flowchart illustrating the an aspect of operation of the preferred embodiment of the invention;

FIG. 3 is a detailed flowchart depicting a further aspect of operation of the preferred embodiment of the invention;

FIG. 4 is a detailed flow chart depicting the analysis and processing of command output relating to the preferred embodiment of the invention.

### DETAILED DESCRIPTION

Organizations and companies are required to support increasingly complex information systems and computer system infrastructures. Typical large networks include many different systems, each with potentially different operating systems such as Windows, Linux, Solaris and other, legacy, systems. Each one of these operating systems require different support tools and specialized expertise and training resulting in high total cost of ownership and lower service levels.

The tool of the preferred embodiment is designed to simplify the support process by providing a common interface to different computer operating systems and application programs that may be used in the enterprise. Using simple menu commands and a browser-based interface, support personnel (tech-users) can diagnose, troubleshoot and resolve problems without having to know a lot about the commands or the operating systems to which they are connected. The access may be made anywhere and anytime. The tool of the preferred embodiment provides potentially increased service levels, greater savings in training and more convenient and easier to accomplish system maintenance.

The tool of the preferred embodiment is implemented by web application software accessed through a browser. The browser-based design provides several advantages. Having the system browser-based means less training for tech-users. Browsers are in common use and therefore minimum training is required to familiarize tech-support with techniques needed to access and use the web pages of the preferred embodiment. The ubiquity of browsers on computers and other web-enabled technology also means that in most cases no client software is required to be installed on computers or other devices that may be used to access the software of the preferred embodiment, thus saving licensing and maintenance costs. The system of the preferred embodiment can be accessed from any operating system or device that will support a web browser. This not only includes PCs but also devices such as wireless handheld devices, cell phones, and other electronic devices that permit a browser to run.

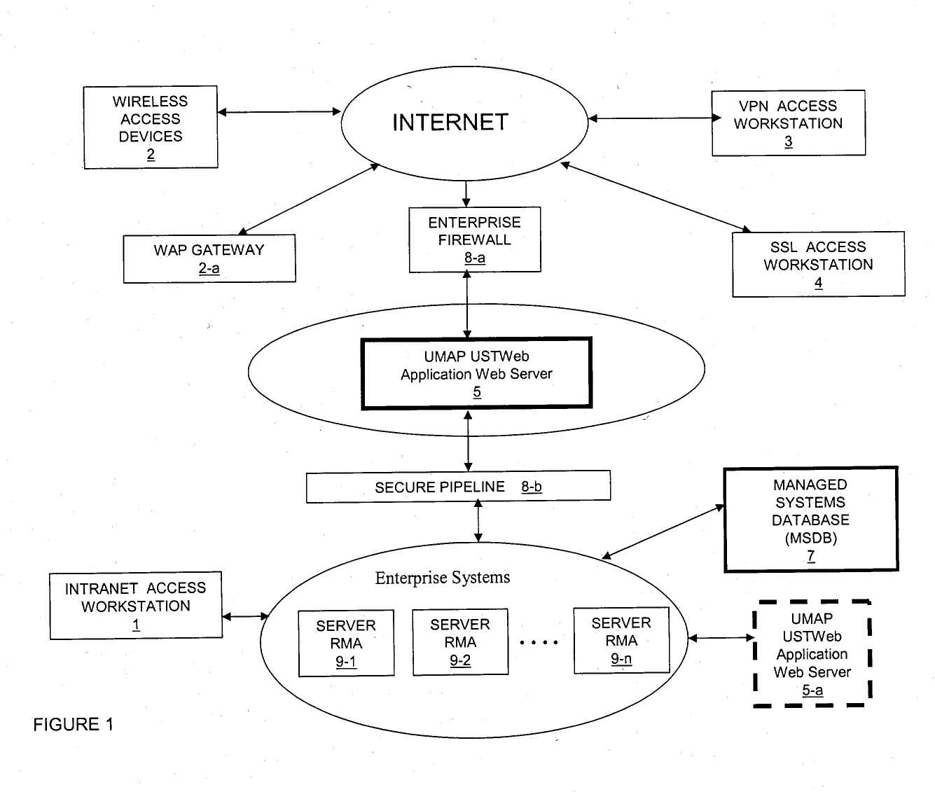

FIG. 1 is a block diagram showing a representative configuration of the systems management tool of the preferred embodiment. The figure identifies several areas of entry into the system as well as the major components. Access to the system may be achieved using intranet access workstation 1. Access using the internet is shown by wireless access devices 2, WAP gateway 2-a, VPN access workstation 3 and SSL access workstation 4. The systems management tool of the preferred embodiment is shown as UMAP USTWeb™ application web server 5. An alternative system design is shown by UMAP USTWeb™ application web server 5-a. Items 5 and 5-a are interchangeable depending on the preference of the enterprise to use the systems management tool of the preferred embodiment internally only (in which case item 5-a may be used) or to use all features through the internet (application web server 5). FIG. 1 also shows managed systems database (MSDB) 7. Communication between the internet and application web server 5 is shown taking place using enterprise firewall 8-a and communication between application web server 5 and servers 9-1, 9-2, . . . 9-n is shown as taking place using secure pipeline 8b. Servers 9-1, 9-2, . . . , 9-n run resident management agent (RMA) software, as is described in more detail below.

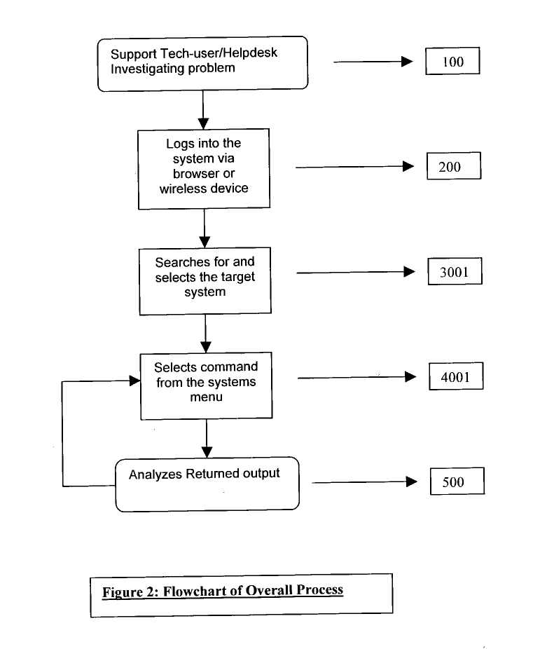

FIG. 2 is a high-level flowchart of the processes involved. In the first step of the process, (process 100), a user of the system, typically a support or helpdesk tech-user might be contacted to investigate a problem on a managed system. The tech-user may use one of several access methods to connect to the management system.

The software of the preferred embodiment includes application web server 5 (or 5-a). This is a Java-based web application server implemented using servlet and Java Server Pages (JSP) technology. It can be deployed and installed on any Java enabled web server such as Apache Tomcat or IBM Websphere. The systems management tool of the preferred embodiment also accesses a backend relational database (MSDB 7). This is used to store system information, a command list, and information concerning the managed servers, users and system and user privileges. A relational database that supports a Java connection may be used. For example commercial relational database systems such those available from Oracle, and those supporting SQL or MySQL are able to be used. This allows the choice to be made for users to utilize their existing web servers and database technologies or alternatively use the ones that may be implemented specifically to work with the systems management tool of the preferred embodiment.

Utilizing Java technology allows the managed systems to be any type of systems that support a Java virtual machine. Java is supported on a wide range of major operating systems. Using Java permits the tech-user to use the tool of the preferred embodiment without having knowledge of the operating systems of the managed systems.

In the system of the preferred embodiment, it is important that commands received by servers 9-1, 9-2, . . . , 9-n are initiated from a source that is able to be trusted by those recipient servers. The preferred embodiment uses a proprietary protocol using digital certificates and encryption to ensure authorized access. Application web server 5 generates a 256 bit symmetric random session key. This key is used to encrypt the request (Command) that will be sent from application web server 5 to the RMA software running on the appropriate server (the “target system”). This session key is used to encrypt the target managed system's Public Encryption Key. The resulting package will be transmitted to the RMA of the target system. The RMA at this point attempts to decrypt the received session key with its private key and then uses the session key to also decrypt the request (Command).

Limiting and restricting tech-users with a set of pre-authorized commands by the administrator further enhance the system security and integrity.

The systems management tool of the preferred embodiment is designed to allow more production support calls to be handled by first level support. This will cut down training costs. For example, any one of the managed systems can be replaced with a different operating system, however the menu of predefined commands presented to the tech-user by application web server 5 may remain the same. This means that tech-support need not be trained in new set of commands when a new system or application has replaced an existing one. For example, the command Reboot Server may be displayed in the same way by the web pages generated by application web server 5 for both old and new systems. The underlying operating system commands may be different for the old and new systems but the system administrator for the systems management tool is able to modify the information available to the application web server such that this change is transparent to the tech-user.

As indicated above, application web server 5 is a web-browser based application residing on a Java-enabled web server implemented using java servlets and Java Server Pages(JSP). The initial setup of application web server 5 requires installation of HTML, JSP, images and Java class files on the web server. It also utilizes MSDB 7 to store the application tables. Application tables hold all system information such as users, commands, managed systems, system menu commands and permissions. In the preferred embodiment, the required data base tables are automatically created during installation by the application web server 5 installation program. These tables are initially populated with default parameters. An administrator will add information such as users, privileges, list of managed servers and their associated list of commands. This is done through administration web pages that are defined in application web server 5 and which are made available to administrators. Application web server 5 communicates with MSDB 7 using defined Java classes executing SQL statements over JDBC drivers.

Post installation and during normal operations, all data and information for application web server 5 is administered using the web page interfaces defined in application web server 5. For instance, if a user is designated as an administrator, the user will have access to a set of HTML and JSP pages that allow the user to add new users, add or delete commands, alter permissions or carry out any other system function. Application web server 5 (or 5-a) and the supporting database MSDB 7 are a tightly coupled system. Administrator's actions through the defined web pages will invoke Java classes to update the database tables. The system tables in MSDB 7 are managed through the UMAP administration pages and classes, including but not limited to: users, commands, permissions, managed systems, menu commands, security policies.

Turning to the servers or systems in the enterprise, shown as 9-1, 9-2, . . . , 9-n in FIG. 1, each of the servers includes its own RMA software. Each RMA consists of a set of Java class files that are installed on each managed system. RMA code is identical for all managed systems, however each system requires its own Java runtime to be installed if it is not already present. Each RMA acts as proxy for transfer of commands and output between the application web server 5 (or 5-a) and the operating system of the managed system.

Depending upon the tech-user's physical circumstances, for example on a train or in transit, the tech-user may choose to use a wireless device equipped with a micro-web browser such as a personal digital assistant (PDA) or a cell phone to connect to the system (as shown by wireless access devices 2 in FIG. 1). Alternatively, a tech-user may use a web browser executing on a personal computer, laptop or tablet device directly connected to the network with access to the management system. Any device equipped with a browser and suitable connection software may be used.

A tech-user enters or selects the appropriate Uniform Resource Locator (URL)—the address that connects the tech-user's device to the management system server software 5—into the remote device's web browser software. The request is sent over the network using a secure channel (SSL or WTLS) to software executing on the web server component of the management system which will present the tech-user with an authentication screen.

Following a successful connection, the tech-user is required to enter credentials into the custom form-based authentication screen (process 200, described in FIG. 2). This is in the form of an application display screen requesting a logonid and password to verify the technician's identity. The tech-user enters credentials and submit them to the management system.

The authentication request is once again sent over a secure (SSL) channel to the application web server 5 executing on the web server component. The application web server 5 will verify the tech-user's input credentials against those stored in the supporting database tables in MSDB 7. This database can reside on the same system as the application web server 5 but would typically be on a separate system. Application web server 5 communicates with the database using Java classes executing SQL statements over JDBC. Tech-user passwords are stored as hash values in the tables of MSDB 7. If the credentials provided by the tech-user fail to match those stored in MSDB 7, the tech-user is redirected back to the logon screen once again. No access is granted until valid credentials are supplied. MSDB 7 also includes a security policy table which allows configuration of items such as the minimum password length and the number of invalid password guesses allowed.

If the credentials provided by the tech-user are valid, application web server 5 performs a search on a table in the supporting database which is used to determine the tech-user's privileges and permitted level of access. The functions and commands the tech-user is allowed to perform while using the management system are pre-assigned and therefore tightly controlled and constrained by these privileges. The tech-user's privileges are set up in advance by system administrator or supervisor using application web server 5. The levels of access are administered through the use of group memberships. For example, a tech-user might be a member of a group called “Helpdesk” which is allowed to inspect system information but not allowed to shutdown a managed system.

Once tech-user's permissions are determined, application web server 5 directs the tech-user's browser to a “home page”. The homepage a web page accessible by the tech-user's browser that provides a starting point to the functions made available by application web server 5. The tech-user's first task is to find and select a managed system (process 300 in FIG. 2). Managed systems are represented by data in MSDB 7 with both a descriptive “system name” and the actual network address/name used in TCP/IP networks. In the preferred embodiment, web pages are provided to the tech-user to permit the tech-user to search and select managed systems using the descriptive “system name”. In this way the tech-user does not require knowledge of the actual network address/name and thus masks the network address and provides a friendlier, less technical interface. For example, the managed system is described to the tech-user by web pages in application web server 5 as “Server on 3^{rd} floor” as opposed to “linux1.dnc” or “10.1.1.100”. The search to make the correspondence between the descriptive name and the actual network name/address is performed by application web server 5 invoking Java classes that query the appropriate tables in MSDB 7.

The software of the preferred embodiment includes a search engine which allows the tech-user to search for a managed system by entering the managed system's name, portions of its name or by the managed system's network name (DNS entry). There is also an option to list all the managed systems.

The search results are displayed as a list of system names (as defined by the administrator, for example “server-2^{nd}-floor”, “exchange-server-10”). The tech-user locates and selects the desired target to be managed with a mouse click on the web page displayed by the browser of the tech-user. In the preferred embodiment, items in the list are displayed in HTML as specially formed URL links, used to pass the managed system's name to other web pages when clicked. This permits other web pages to be built dynamically, using HTML, based on the information passed.

When a system is selected from the list of search results, a dynamically created menu (Dynamic Command Menu-DCM) for the target system is presented to the tech-user by application web server 5. This is accomplished by redirecting to a Java Server Page (JSP) which calls Java classes to search the MSDB 7 command tables for matching system entries. The JSP retrieves all matching commands for the passed system and formats the data into a presentable HTML page. This menu (DCM) is a customized list of commands or actions for each managed system (9-1, 92, 0.9-n in FIG. 1). The list is typically set up and created by an administrator using the application web server 5 administration pages.

In the preferred embodiment, there is a menu provided to the administrator on an administration web page and the administrator is able to select “add commands” from the menu. The menu in the preferred embodiment contains a list of typical actions that are performed on that specific managed system or other similar managed systems. The list is a descriptive link and does not display the actual operating system (O/S) command. The list is made up of specially formed URLS which embed the actual O/S command. For example, the DCM might contain items such as “Restart the server”, “Clear the print queue” or “Show logged users”. Behind the link is a specially coded URL which includes the actual O/S command. In this way, the command can be forwarded along to other web pages in application web server 5 and ultimately to the appropriate RMA.

The items on the DCM are customizable and can be unique per each managed system or groups of similar managed systems. Commands can be added dynamically through application web server 5 administration pages. In addition to referring to the DCM list, in the preferred embodiment, more experienced tech-users may enter O/S commands directly into an entry field. The entry field method allows for execution of O/S commands that are not on the DCM list, where the tech-user has authorization to initiate such commands.

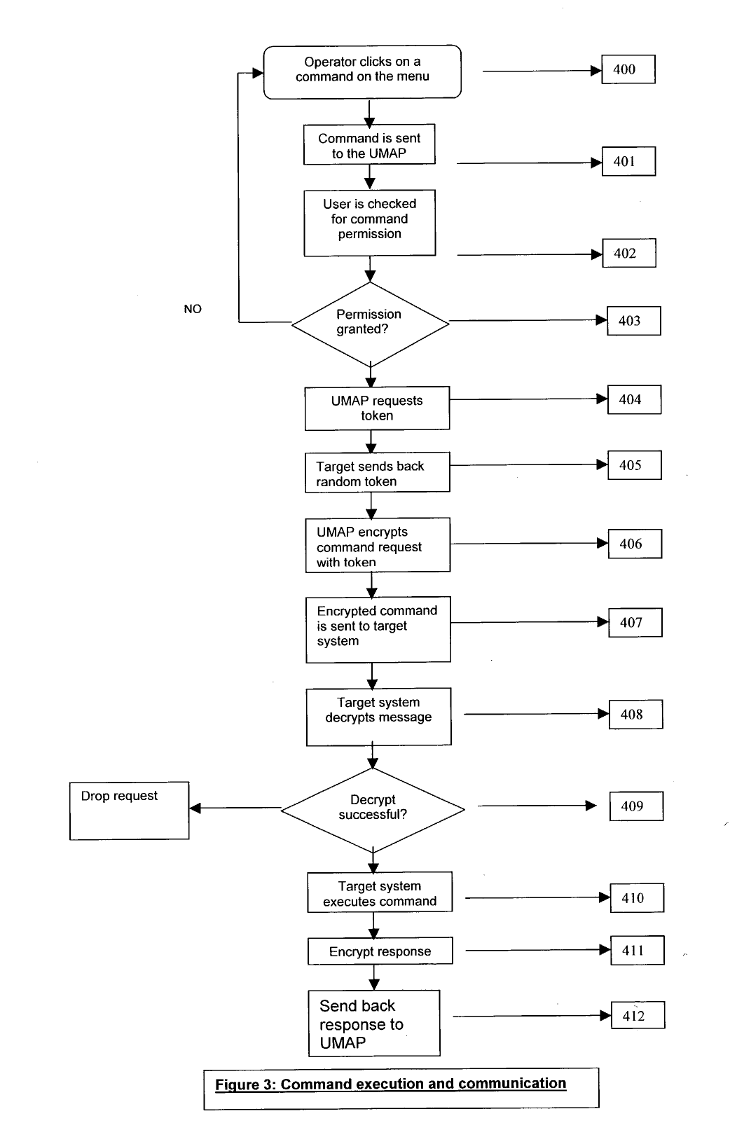

When a tech-user selects an item from the DCM (process 400 in FIG. 2) or enters an O/S command in the entry field, the information is sent to application web server 5 for processing (step 401 in FIG. 3). Application web server 5 performs a permission check against the database of MSDB 7 to verify the tech-user's authorization for executing the command (step 402 in FIG. 3). If the tech-user is not authorized, the tech-user is presented with an error message indicating that access was denied.

Upon successful verification, application web server 5 prepares to send the executable command to the Resident Management Agent (RMA) of the appropriate managed system for execution. In the preferred embodiment, communications between application web server 5 and systems 9-1, 9-2, . . . , 9-n use secure pipeline 8b which employs a proprietary format based on XML and in which communications are encrypted to protect confidentiality.

Communications on secure pipeline 8-b of the preferred embodiment include a proprietary handshake with the managed system. Before the actual command is sent, the RMA of the managed system is requested to send back a random code (step 404 in FIG. 3). The received random code is then packaged along with the selected command into an Encrypted Action Request Package (EARP) and then returned to the RMA (step 407 in FIG. 3). If the RMA does not recognize the random code embedded in the newly arrived EARP, the request is denied, otherwise, the RMA proceeds to decrypt the command embedded in the EARP (step 408 in FIG. 3). This is another layer of security and decryption. Where failure in the above steps occurs it is possibly due to a fraudulent request and the access will be denied. In the preferred embodiment, application web server 5 resides behind enterprise firewall 8-a but communication from application web server 5 may have possibly been compromised, and therefore any communication between the RMAs and the UMAP must be secure and identifiable by both components.

Upon successful execution of the above process (shown as step 408 in FIG. 3), the appropriate RMA proceeds to execute the actual O/S command (step 410 in FIG. 3). This is accomplished by invoking a Java system call to pass the command directly to the underlying operating system on which the RMA is running. The output of the command and any error information is captured by the RMA, encrypted and sent back to application web server 5 (step 411 in FIG. 3). Once again, the response is sent back in an encrypted and proprietary XML format. The encryption/decryption provides a form of mutual authentication between application web server 5 and the RMA. Only application web server 5 and RMA have the required information to decrypt each other's messages.

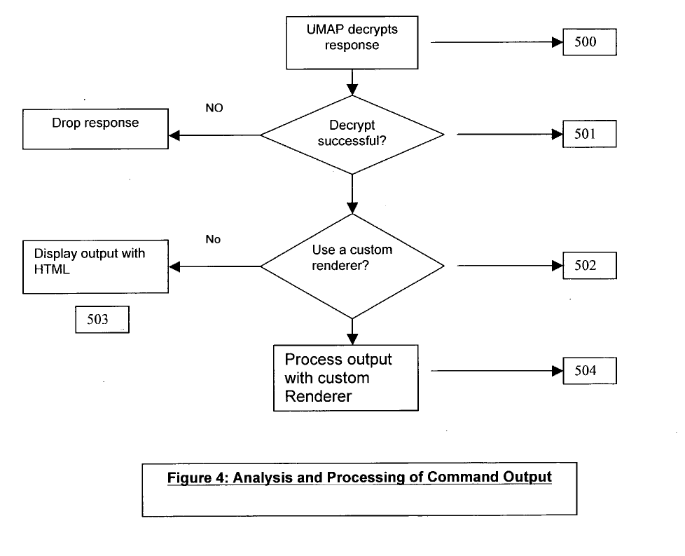

Once RMA's feedback is returned to application web server 5 and the decryption is successful, application web server 5 performs a check on the original command sent (step 500 in FIG. 4). In the preferred embodiment, if the command was marked as “standard”, the output is formatted in simple HTML and returned to the tech-user's browsers as the command's “raw” output (step 503 in FIG. 4). If the command was marked as “custom”, the output is redirected through a specified custom renderer associated with application web server 5 (step 504 in FIG. 4). The custom renderer is a special program written for the command which can parse the output data and take alternative actions. For example, the data can be presented in bar charts or graphs instead of the raw command output. Or the renderer might issue an alert in the form of a page or email if portions of the command output contain certain information.

If the command is originated from a wireless handheld device, the output is directed back to the device and rendered on the device's display.

As may be seen from the above, the systems management tool of the preferred embodiment provides for a consistent access of multiple servers having different operating systems. The user seeking to provide commands to different systems need not have a specific or detailed knowledge of the different operating systems used on servers in the enterprise. Access is available from different devices that support a web-based browser.

Although a preferred embodiment of the present invention has been described here in detail, it will be appreciated by those skilled in the art that other variations may be made. For example, the SGML or XML definitions used as inputs for the development tool may be in form other than files. Such variations may be made without departing from the spirit of the invention or the scope of the appended claims.

What is claimed is:

1. A computer program product for systems management, the program product comprising a computer usable medium tangibly embodying computer readable program code means for implementing an application web server for managing computer systems, the computer readable program code means comprising:
code means for making available to a web browser a set of web pages to provide system support functionality for a set of managed computer systems,
code means for accessing and maintaining a managed systems central data base for storing and retrieving data relating to the set of managed computer systems,
code means for implementing a resident management agent for execution on each one of the set of managed computer systems,
code means for ensuring security and integrity against intrusions and unauthorized access to the set of managed computer systems and to the application web server,
code means for authentication and connection to the application web server from wireless devices
code means for providing secure communication between the application web server and the set of managed computer systems; and
means for allowing customization of commands and control parameters in the application web server,
wherein the application web server is securely accessibly by a web browser to provide commands to one or more of the set of managed computer systems.

2. The computer program product means of claim 1 wherein the application web server further comprises:
code means for custom rendering command output,
code means for searching and obtaining data from the managed systems central data base for one or more resident management agents; and
code means for searching to identify and verify user rights and privileges for one or more of the resident management agents.

3. The computer program product of claim 1 in which the code means for making available to a web browser a set of web pages further comprises means to make the web pages available to wireless devices.
